(19) United States
(12) Patent Application Publication
(10) Pub. No.: US 2018/0171877 A1
(43) Pub. Date: Jun. 21, 2018

(54) Power Generation System and Method for Operating Same

(71) Applicant: General Electric Company, Schenectady, NY (US)

(72) Inventors: Thomas Ory Moniz, Loveland, OH (US); Patrick Sean Sage, West Chester, OH (US)

(21) Appl. No.: 15/380,176

(22) Filed: Dec. 15, 2016

(51) Int. Cl. F02C 9/18; F02C 3/04; F02C 7/057; F02C 7/042; F01D 15/10

(52) U.S. Cl. CPC F02C 9/18; F02C 3/04; F02C 7/057; F05D 2240/35; F01D 15/10; F05D 2220/32; F02C 7/042

(57) ABSTRACT

In one aspect, a power generation system may include a core turbine engine, an electric generator, an electric motor, and an auxiliary compressor. The core turbine engine defines an axial direction, and may include a compressor and a turbine in serial flow relationship along the axial direction. The electric generator may be operatively coupled to and driven by the core turbine engine. In addition, the electric motor may be in electrical communication with the electric generator for receiving electrical power generated by the electric generator. Furthermore, the auxiliary compressor may be positioned upstream of the compressor of the core turbine engine, and the auxiliary compressor may be rotatable by the electric motor to compress a volume of air to be provided to the compressor of the core turbine engine.

### FIELD

The present subject matter relates generally to a power generation system and method for operating the power generation system.

### BACKGROUND

A core of a gas turbine engine generally includes, in serial flow order, a compressor section, a combustion section, and a turbine section. In operation, ambient air is provided to an inlet of the compressor section where one or more axial compressors progressively compresses the air until it reaches the combustion section. Fuel is mixed with the compressed air and burned within the combustion section to provide combustion gases. The combustion gases are then routed from the combustion section to the turbine section. The flow of combustion gases through the turbine section drives the turbine section.

In certain applications, the core of the gas turbine engine may be used within a portable power generation system that provides electrical power to a load. The core may be derived from a gas turbine engine (e.g., turbofan) suitable for aeronautical applications, and the derived core generally includes, in serial flow order, a low pressure (LP) compressor, a high pressure (HP) compressor, a combustor, a HP turbine, and a LP turbine. The HP turbine is generally coupled to the HP compressor via a HP shaft, and the LP turbine is generally coupled to the LP compressor via a LP shaft that also drivingly connects the LP turbine to an output shaft. In addition, the power generation system also generally includes an electric generator coupled to the output shaft. As such, during operation of the power generation system, the LP turbine drives rotation of the output shaft, and the electric generator converts rotational motion of the output shaft to electrical power that is subsequently delivered to the load.

Certain power generation systems requiring lower power requirements may remove the LP compressor. However, removing the LP compressor may negatively affect a peak power and/or efficiency of the core turbine engine. In particular, a pressure ratio of the compressor section may be diminished, because removal of the LP compressor decreases a number of stages within the compressor section.

Accordingly, a need exists for improving the peak power of power generation systems lacking a LP compressor.

### BRIEF DESCRIPTION

Aspects and advantages of the invention will be set forth in part in the following description, or may be obvious from the description, or may be learned through practice of the invention.

In an exemplary embodiment, a power generation system includes a core turbine engine, an electric generator, an electric motor, and an auxiliary compressor. The core turbine engine defines an axial direction, and the core turbine engine includes a compressor and a turbine in serial flow relationship along the axial direction. The electric generator may be operatively coupled to and driven by the core turbine engine. In addition, the electric motor may be in electrical communication with the electric generator for receiving electrical power generated by the electric generator. Furthermore, the auxiliary compressor may be positioned upstream of the compressor of the core turbine engine, and the auxiliary compressor may be rotatable by the electric motor to compress a volume of air to be provided to the compressor of the core turbine engine.

In another exemplary embodiment, a method of operating a power generation system comprising a core turbine engine, an electric generator, an electric motor, and an auxiliary compressor includes rotating the electric generator with the core turbine engine to generate electrical power with the electric generator. The method may also include powering the electric motor with a portion of the electric power generated by the electric generator. In addition, the method may include driving the auxiliary compressor with the electric motor to compress an airflow provided to a compressor of the core turbine engine.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 is a schematic cross-sectional view of an exemplary power generation system according various embodiments of the present subject matter;

FIG. 2 is a schematic cross-sectional view of an exemplary power generation system according to another embodiment of the present subject matter;

FIG. 3 is a schematic cross-sectional view of one embodiment of an auxiliary compressor that may be used within the power generation system of FIGS. 1 and 2;

FIG. 4 illustrates a block diagram of one embodiment of an exemplary controller that may be used within the power generation system of FIGS. 1 and 2; and

FIG. 5 illustrates a flow diagram of one embodiment of a method for operating the power generation system of FIGS. 1 and 2 in accordance with aspects of the present subject matter.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first” and “second” may be used interchangeably to distinguish one component from another and are not intended to signify location or importance of the individual components. The terms “forward” and “aft” refer to relative positions within a gas turbine engine, with forward referring to a position closer to an engine inlet and aft referring to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows.

In general, the present disclosure is directed to a power generation system and method for operating the power generation system. Specifically, in accordance with aspects of the present subject matter, the power generation system may include a core turbine engine and an electric generator. The core turbine engine includes, in serial flow order, a compressor section, a combustion section and a turbine section. The compressor, combustion, and turbine sections together define, at least in part, a core air flowpath. The electric generator may be operatively coupled to and driven by the core turbine engine to generate electrical power. The power generation system may also include an electric motor and an auxiliary compressor. As will be discussed below in more detail, the auxiliary compressor may be rotatable by the electric motor to increase a pressure ratio of the compressor. In addition, increasing the pressure ratio of the compressor may increase an overall pressure ratio of the power generation system and, as a result, may increase the amount of power generated by the electric generator. Accordingly, the power generation system may provide additional power without substantially increasing the overall weight of the system.

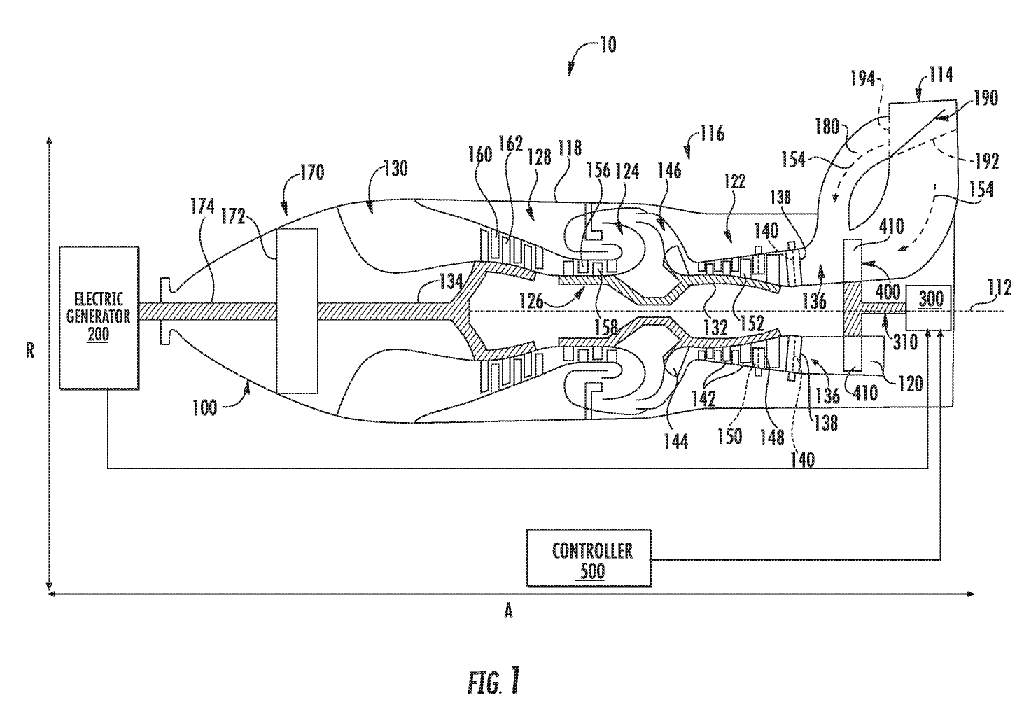

Referring now to the drawings, wherein identical numerals indicate the same elements throughout the figures, FIG. 1 is a schematic, cross-sectional view of a power generation system 10 in accordance with an exemplary embodiment of the present disclosure. The power generation system 10 includes a gas turbine engine 100. More particularly, for the embodiment of FIG. 1, the gas turbine engine 100 is a turboshaft engine. It should be appreciated, however, that in other exemplary embodiments, the gas turbine engine 100 may instead be configured as any other suitable gas turbine engine. For example, in one exemplary embodiment, the gas turbine engine 100 may be a turbofan engine.

As shown in FIG. 1, the gas turbine engine 100 defines an axial direction A (extending parallel to a longitudinal centerline 112), a radial direction R, and a circumferential direction (i.e., a direction extending about the axial direction A; not depicted). In general, the gas turbine engine 100 includes an inlet duct 114 and a core turbine engine 116. As will be discussed below in more detail, air may enter the core turbine engine 116 through the inlet duct 114.

The exemplary core turbine engine 116 depicted generally includes a substantially tubular outer casing 118 that encloses an annular, radial duct 120 positioned downstream of the inlet duct 114. More specifically, the radial duct 120 is in fluid communication with the inlet duct 114, and includes at least a portion extending generally along the radial direction R. The radial duct 120 is configured to turn a direction of air flow from the inlet duct 114 such that the resulting airflow is generally along the axial direction A. Additionally, the outer casing 118 encases, in serial flow order, a compressor section including a high pressure (HP) compressor 122; a combustion section including a combustor 124; a turbine section including a HP turbine 126 and a low pressure (LP) turbine 128; and an exhaust section 130. Moreover, the core turbine engine 116 includes a HP shaft or spool 132 coupling the HP turbine 126 to the HP compressor 122, and a low pressure (LP) shaft or spool 134 coupled to the LP turbine 128, and drivingly connecting the LP turbine 128 to an output shaft assembly 170. As shown, the output shaft assembly 170 depicted includes a gear box 172 and an output shaft 174. However, in other embodiments, the output shaft assembly 170 may not include the gear box 172.

The compressor section, combustion section, and turbine section together define a core air flowpath 136 through the core turbine engine 116. Notably, for the embodiment depicted, the core turbine engine 116 further includes a stage of inlet guide vanes 138 at a forward end of the core air flowpath 136. Specifically, the inlet guide vanes 138 are positioned at least partially within the radial duct 120, the radial duct 120 located upstream of the HP compressor 122. As shown, the HP compressor 122 is located downstream of the stage of inlet guide vanes 138. Further, the exemplary stage of inlet guide vanes 138 of FIG. 1 are configured as variable inlet guide vanes 138. The variable inlet guide vanes 138 are each rotatable about a pitch axis 140, allowing for the variable inlet guide vanes 138 to direct an airflow through the radial duct 120 and into the HP compressor 122 in a desired direction. In certain embodiments, each of the variable inlet guide vanes 138 may be configured to rotate completely about the respective pitch axis 140, or alternatively, each of the plurality of variable inlet guide vanes 138 may include a flap or tail configured to rotate about a respective pitch axis 140. It should be appreciated, however, that in still other exemplary embodiments, each of the plurality of inlet guide vanes 138 may not be configured to rotate about a respective pitch axis 140, and instead may include any other suitable geometry or configuration allowing for a variance in a direction of the airflow over the variable guide vanes 138. Additionally, in other exemplary embodiments, the stage of inlet guide vanes 138 may instead be located at any other suitable location within the radial inlet duct 120.

Furthermore, the HP compressor 122 may include at least four stages of compressor rotor blades. More specifically, for the embodiment depicted, the HP compressor 122 includes four stages of radially oriented compressor rotor blades 142, and an additional stage of centrifugal compressor rotor blades 144. As is depicted, the core turbine engine 116 further includes a transition duct 146 immediately downstream of the HP compressor 122, the transition duct 146 having at least a portion extending generally along the radial direction R to provide a compressed air flow from the HP compressor 122 to the combustor 124. The stage of centrifugal compressor rotor blades 144 are configured to assist with turning the compressed air within the compressor section radially outward into the transition duct 146. Notably, however, in other exemplary embodiments, the combustion section may not include the reverse flow combustor 124. With such an exemplary embodiment, the HP compressor 122 may not include the stage of centrifugal compressor rotor blades 144.

Additionally, between each stage of compressor rotor blades 142, 144, the compressor section includes a stage of compressor stator vanes. Notably, the first stage of compressor stator vanes is configured as a stage of variable compressor stator vanes 148, such that each of the variable compressor stator vanes 148 may rotate about a respective pitch axis 150. By contrast, the remaining stages of compressor stator vanes are configured as fixed compressor stator vanes 152. Such a configuration may assist with increasing an overall pressure ratio of the HP compressor 122. For example, the HP compressor 122 having the multiple number of stages of compressor rotor blades 142, 144, and optionally including a stage of variable compressor stator vanes 148, in addition to being located downstream of a stage of variable inlet guide vanes 138, may allow for the HP compressor 122 to operate in a more efficient manner. It should be appreciated, however, that in other embodiments, the compressor section may be configured in any other suitable manner.

It will be appreciated, that during operation of the power generation system 10, a volume of air 154 enters the gas turbine engine 100 through the inlet duct 114, and subsequently flows to the radial duct 120. The volume of air 154 then flows across the variable inlet guide vanes 138 and into the HP compressor 122 of the compressor section. A pressure of the volume of air 154 increases as it is routed through the HP compressor 122, and is then provided to the combustor 124 of the combustion section, where the air is mixed with fuel and burned to provide combustion gases. The combustion gases are routed through the HP turbine 126 where a portion of thermal and/or kinetic energy from the combustion gases is extracted via sequential stages of HP turbine stator vanes 156 that are coupled to the outer casing 118 and HP turbine rotor blades 158 that are coupled to the HP shaft 132, thus causing the HP shaft 132 to rotate, thereby supporting operation of the HP compressor 122. The combustion gases are then routed through the LP turbine 128 where a second portion of thermal and kinetic energy is extracted from the combustion gases via sequential stages of LP turbine stator vanes 160 that are coupled to the outer casing 118 and LP turbine rotor blades 162 that are coupled to the LP shaft 134, thus causing the LP shaft 134 to rotate. The combustion gases are subsequently routed through the exhaust section 130 of the core turbine engine 14. As will be discussed below in more detail, the power generation system 10 may include additional components to increase the pressure ratio of the HP compressor 122.

As shown, the power generation system 10 additionally includes an electric generator 200 operatively coupled to the core turbine engine 116. More specifically, in the exemplary embodiment depicted, the electric generator 200 is coupled to the output shaft 174, and the electric generator 200 is configured to convert rotational motion of the output shaft 174 to electrical power. The output shaft 174 is driven by the LP shaft 134 across the gearbox 172 of the output assembly 170. Accordingly, for the embodiment depicted, the electric generator 200 is generally driven by the LP shaft 134.

The electric generator 200 may be any suitable generator configured to generate electrical power. For example, the electric generator 200 may be a single phase alternating current (AC) generator configured to generate an alternating electric current due, at least in part, to rotation of the output shaft 174. As will be discussed below in more detail, a portion of the electrical power generated by the electrical generator 200 may be used by the power generation system 10.

As is also shown, the power generation system 10 further includes an electric motor 300. The electric motor 300 may be in electrical communication with the electrical generator 200 via any suitable wired or wireless manner. As such, the electric motor 300 may receive at least a portion of the electrical power generated by the electrical generator 200. It should be appreciated that the electric motor 300 may be any suitable type of electric motor. For example, in one embodiment, the electric motor 300 may be an AC motor. In alternative embodiments, the electric motor 300 may be a direct current (DC) motor. As will be discussed below in more detail, the electric motor 300 may use the electrical power from the electrical generator 200 to compress the volume of air 154 prior to entering the HP compressor 122.

More particularly, the power generation system 10 also includes an auxiliary compressor 400 which, for the embodiment depicted, is positioned within the outer casing 118 of the core turbine engine 116. In particular, the auxiliary compressor 400 may be an LP compressor positioned at any suitable location upstream from the HP compressor 122. For the embodiment depicted, the auxiliary compressor 400 includes an array of airfoils 410 positioned within the radial duct 120. The array of airfoils 410 are rotatably coupled to an output shaft 310 of the electric motor 300, and both the output shaft 310 and the array of airfoils 410 may be rotated by the electric motor 300. More specifically, for the embodiment depicted in FIG. 1, the electric motor 300 uses the electrical power generated by the electric generator 200 to rotate both the output shaft 310 and the array of airfoils 410 about the axial direction A. In one exemplary embodiment, the auxiliary compressor 400, specifically the array of airfoils 410, rotates coaxially with the HP shaft 132 of the core turbine engine 116 along the axial direction A.

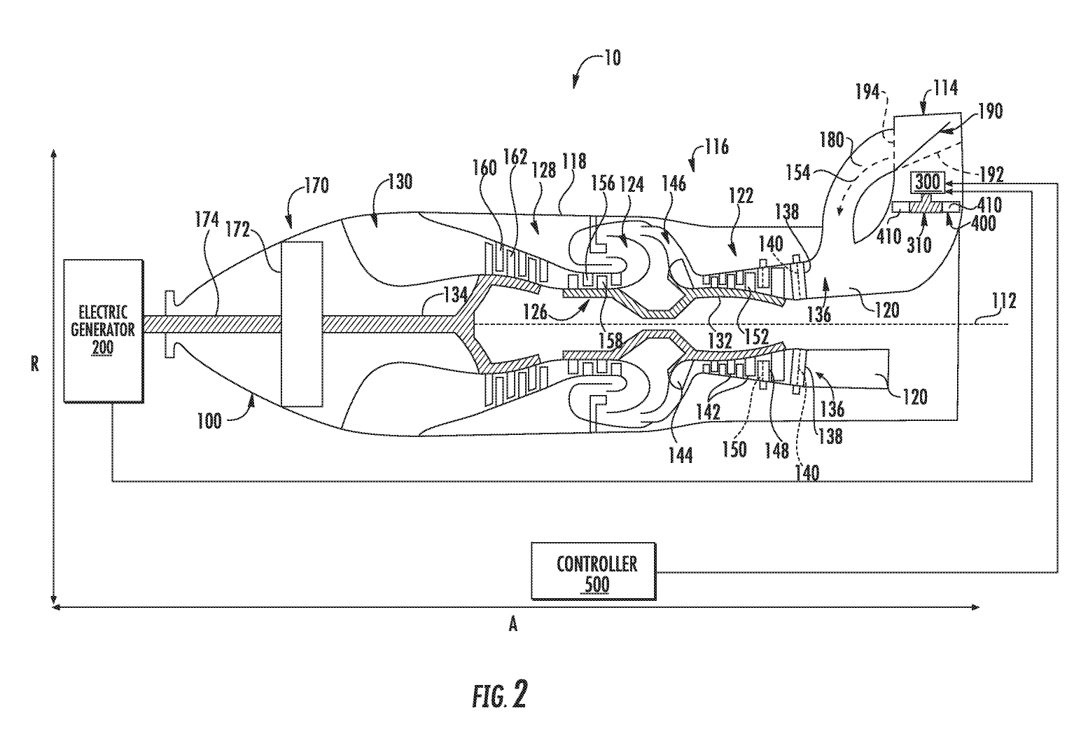

It should be appreciated, however, that the position of the auxiliary compressor 400 depicted in FIG. 1 is by way of example only. Referring briefly now to FIG. 2, an alternative embodiment of the power generation system 100 is depicted. As shown the auxiliary compressor 400 may not rotate coaxially with the HP shaft 132 along the axial direction A, and the array of airfoils 410 may not be positioned within the radial duct 120. For example, for the exemplary embodiment of FIG. 2, the output shaft 310 of the electric motor 300 is spaced apart from the HP shaft 132 along the radial direction R and/or defines an angle greater than zero with the HP shaft 132. Accordingly, for the embodiment depicted (and potentially in other exemplary embodiments) the auxiliary compressor 400 does rotate coaxially with the HP shaft 132, i.e., the auxiliary compressor 400 is misaligned with the HP shaft 132. Notably, with such an embodiment, the array of airfoils 410 may be positioned at any suitable location upstream of the HP compressor 122, such as within the inlet duct 114 (shown).

Referring again to FIG. 1, it should be appreciated that rotation of the array of airfoils 410 compresses the volume of air 154 prior to such air 154 entering the HP compressor 122 and, as a result, increases an overall pressure ratio of the power generation system 10. For example, the HP compressor 122 may define a pressure ratio of at least about 15 and the auxiliary compressor 400 may define a pressure ratio of at least about 1.2, such that the power generation system 10 may define overall pressure ratio of at least about 18. Alternatively, in other exemplary embodiments, the HP compressor 122 may instead define a pressure ratio of at least about 19, the auxiliary compressor 400 may define a pressure ratio of at least about 1.3, and the power generation system 10 may define an overall pressure ratio of at least about 25.

It should be appreciated, that as used herein, the term “pressure ratio” refers to a ratio of a pressure of an airflow exiting the component to a pressure of an airflow entering the component during rotation at a maximum speed. For example, the pressure ratio of the auxiliary compressor 400 refers to a ratio of a pressure immediately downstream from the plurality of airfoils to a pressure immediately upstream of the plurality of airfoils during operation of the auxiliary compressor 400 at a maximum speed. Similarly, the pressure ratio of the HP compressor 122 refers to a ratio of a pressure immediately downstream from the HP compressor 122 to a pressure immediately upstream of the HP compressor 122. Furthermore, for the embodiment depicted, the overall pressure ratio of the power generation system 10 refers to a ratio of a pressure immediately downstream of the HP compressor 122 to a pressure immediately upstream of the plurality of airfoils of the auxiliary compressor 400.

Given the above operation of the auxiliary compressor 400, it should further be appreciated that in certain exemplary embodiments, the auxiliary compressor 400 may additionally be used to start the power generation system 10. For example, the auxiliary compressor 400 may generate an airflow through the core turbine engine 116 to begin rotating the HP compressor 122 and HP turbine 126 to start the core turbine engine 116.

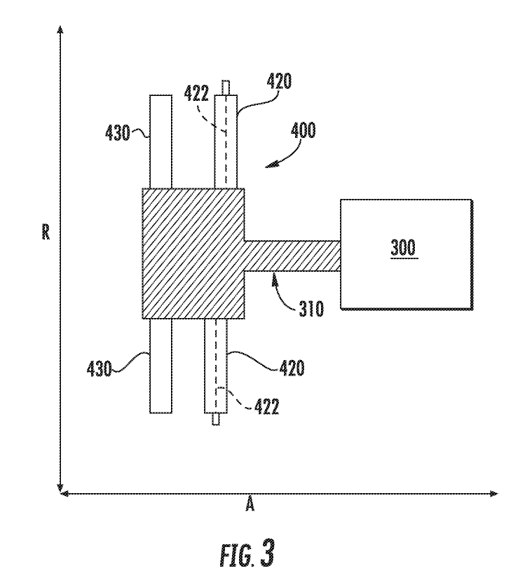

Referring now briefly to FIG. 3, in one exemplary embodiment, the array of airfoils 410 (FIG. 1) may include a first array of airfoils 420 and a second array of airfoils 430 spaced apart from the first array of airfoils 420 along the axial direction A. In addition, each airfoil of the first array of airfoils 420 are, for the embodiment depicted, configured as a variable vane rotatable about a respective pitch axis 422. The variable vanes of the first array of airfoils 420 are, for the embodiment depicted, mounted to the outer casing 118. The second array of airfoils 430 are mounted to the shaft 310 such that the second arrays of airfoils 430 are rotatable by the electric motor 300.

Referring again to FIG. 1, the gas turbine engine 100 depicted defines a bypass duct 180 and a valve 190. For the embodiment depicted, the valve 190 is configured as a blocker door rotatably hinged to the annular casing 118 of the core turbine engine 116. However, in other embodiments, any other form of valve 190 may be used. As shown, the valve 190 is movable between a first position 192 and a second position 194 to control the flow path of the volume of air 154. When the valve 190 is in the first position 192, the volume of air 154 entering the inlet duct 114 may be directed into the bypass duct 180 and, as a result, may bypass the auxiliary compressor 400. More specifically, the volume of air 154 may flow directly to the stage of inlet guide vanes 138 positioned immediately upstream of the HP compressor 122. In contrast, when the valve 190 is in the second position 194, the volume of air 154 entering the inlet duct 114 may be directed to the auxiliary compressor 400. More specifically, the volume of air 154 may flow across the array of airfoils 410 positioned upstream from the stage of inlet guide vanes 138.

Notably, however, in other exemplary embodiments, any other suitable configuration may be provided for either bypassing the auxiliary compressor 400 or minimizing a drag on the auxiliary compressor 400 during low power use (e.g., when the auxiliary compressor 400 is not in use). For example, in other exemplary embodiments, the array of airfoils 410 of the auxiliary compressor 400 may be configured to windmill (i.e., rotate with minimum resistance). With such an exemplary embodiment, any variable geometry components, such as variable stator vanes, may also be set to reduce an amount of drag.

It should also be appreciated that utilization of the auxiliary compressor 400 may affect the peak power and efficiency of the power generation system 10. More specifically, a peak power of the power generation system 10 is increased when the auxiliary compressor 400 is used to increase an overall pressure ratio of the power generation system 10 (as the volume of air 154 is compressed by both the auxiliary compressor 400 and the HP compressor 122). However, utilization of the auxiliary compressor 400 to increase the peak power of the power generation system 10 decreases an overall efficiency of the system 10. Accordingly, when the valve 190 is in the second position 194 and the auxiliary compressor 400 is operating, a peak power of the power generation system 10 may be increased, while an overall efficiency of the power generation system 10 may be decreased. By contrast, when the valve 190 is in the first position and the auxiliary compressor 400 is not operating, a peak power of the power generation system 10 may be decreased, while an overall efficiency of the power generation system 10 may be increased.

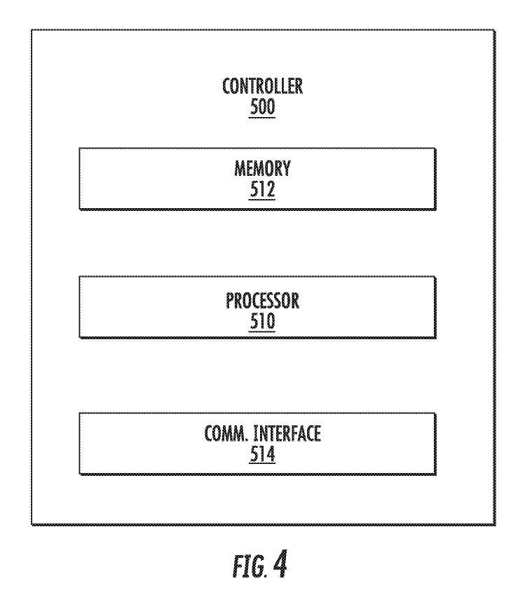

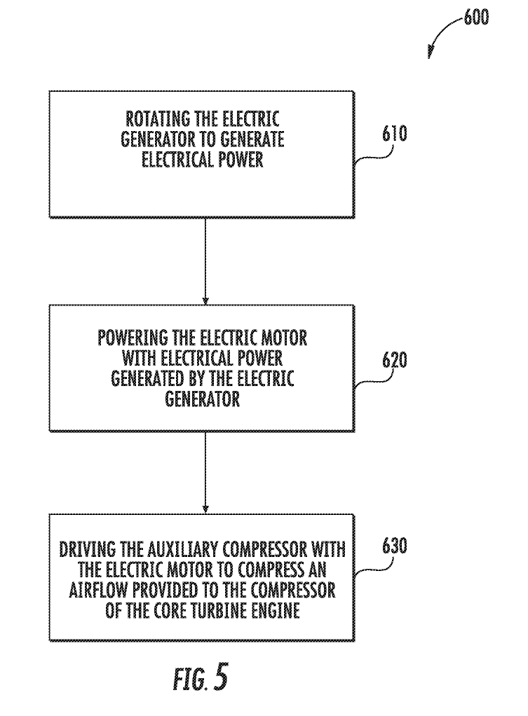

The exemplary power generation system 10 also includes a controller 500. In general, the controller 500 may correspond to any suitable processor-based device, including one or more computing devices. For instance, FIG. 4 illustrates one embodiment of suitable components that may be included within the controller 500. As shown in FIG. 4, the controller 500 may include a processor 510 and associated memory 512 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, microcontroller, a microcomputer, a programmable logic controller (PLC), an application specific integrated circuit (ASIC), a Field Programmable Gate Array (FPGA), and other programmable circuits. Additionally, the memory 512 may generally include memory element(s) including, but not limited to, computer readable medium (e.g., random access memory (RAM)), computer readable non-volatile medium (e.g., flash memory), a compact disc-read only memory (CD-ROM), a magneto-optical disk (MOD), a digital versatile disc (DVD) and/or other suitable memory elements or combinations thereof. The memory 512 may store instructions that, when executed by the processor 510, cause the processor 510 to perform operations. The operations may include one or more of the operations described below, e.g., with respect to the method of FIG. 5.

Additionally, as shown in FIG. 4, the controller 500 may also include a communications interface module 514. In several embodiments, the communications interface module 514 may include associated electronic circuitry that is used to send and receive data. As such, the controller 500 may be communicatively coupled to the electric motor 300 via the communications interface module 514 and, as a result, the controller 500 may send and receive data to and from the electric motor 300. Alternatively, or in addition to, the controller 500 may, via the communications interface module 514, be communicatively coupled to any other suitable components of the power generation system 10. For example, the controller 500 may be used to communicate with any number of sensors configured to monitor one or more operating parameters of the core turbine engine 114. In one exemplary embodiment, the controller 500 may be used to communicate with a pressure sensor configured to monitor a discharge pressure (P_{S3}) of the HP compressor 122. Alternatively, or in addition to, the controller 500 may be used to communicate with a temperature sensor configured to measure a turbine gas temperature (T_{4.5}) of the HP turbine 126.

In one exemplary embodiment, the controller 500 may be used to control the operation of the electric motor 300 based, at least in part, on one or more operating parameters received from one or more sensor(s) of the gas turbine engine 100. For example, the controller 500 may control the rotational speed of the output shaft 310 based, at least in part, on the one or more operating parameters. In addition, the controller 500 may also be used to control the operation of the valve 190. More specifically, the controller 500 may command the valve 190 to move from the first position 192 to the second position 194, or vice versa. Alternatively, or in addition to, the controller 500 may be communicatively coupled to the electric generator 200 to monitor the power output of the electric generator 200. More specifically, the controller 500 may be communicatively coupled to a sensor of the electric generator 200 that is configured to measure the power output of the electric generator 200. It should be appreciated that the sensor of the electric generator 200 may be any suitable sensor configured to measure power output.

Referring now to FIG. 5, a flow diagram of one embodiment of a method for operating a power generation system is illustrated in accordance with the present disclosure. The exemplary method of FIG. 5 may be utilized with the exemplary power generation system 10 described above with reference to FIGS. 1 and 2. In addition, although FIG. 5 depicts steps performed in a particular order for purposes of illustration and discussion, the methods discussed herein are not limited to any particular order or arrangement. It will be appreciated that various steps of the methods disclosed herein can be omitted, rearranged, combined, and/or adapted in various ways without deviating from the scope of the present disclosure.

As shown in FIG. 5, the method (600) includes, at (610), rotating the electric generator with the core turbine engine to generate electrical power with the electric generator. More specifically, in one exemplary embodiment, the electric generator may be coupled to the LP shaft of the LP turbine and, as a result, may convert rotational motion of the LP shaft to electrical power. At (620), the method (600) includes powering the electric motor with at least a portion of the electrical power generated by the electrical generator. More specifically, the electric motor may be in electrical communication with the electric generator via any suitable wired or wireless manner.

At (630), the method (300) includes driving the auxiliary compressor with the electric motor to compress the volume of air provided to the HP compressor. It should be appreciated that the auxiliary compressor includes an array of airfoils and is positioned at any suitable location positioned upstream from the HP compressor. For example, in one exemplary embodiment, the auxiliary compressor, including the array of airfoils, are positioned upstream from the stage of variable inlet guide vanes. Notably, when the power generation system includes a bypass duct, driving the auxiliary compressor with the electric motor at (630) may further include moving a valve in fluid communication with the bypass duct to an open position to allow an airflow through the auxiliary compressor.

This written description uses examples to disclose the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power generation system comprising:
a core turbine engine defining an axial direction, the core turbine comprising a compressor and a turbine in serial flow relationship along the axial direction;
an electric generator operatively coupled to and driven by the core turbine engine;
an electric motor in electrical communication with the electric generator for receiving electrical power generated by the electric generator; and
an auxiliary compressor positioned upstream of the compressor of the core turbine engine and rotatable by the electric motor to compress a volume of air to be provided to the compressor of the core turbine engine.

2. The power generation system of claim 1, further comprising:
a controller communicatively coupled to the electric motor, the controller configured to control the operation of the electric motor based, at least in part, on one or more operating parameters of the core turbine engine.

3. The power generation system of claim 2, wherein the one or more operating parameters of the core turbine engine comprises at least one of a compressor discharge pressure, a turbine gas temperature, and a rotational speed of a low pressure shaft of the core turbine engine.

4. The power generation system of claim 1, wherein the auxiliary compressor comprises an array of airfoils rotatable by the electric motor.

5. The power generation system of claim 4, wherein the array of airfoils includes a first array of airfoils and a second array of airfoils, and wherein the second array of airfoils are rotatable by the electric motor.

6. The power generation system of claim 5, wherein each airfoil of the first array of airfoils is a variable vane movable about a pitch axis.

7. The power generation system of claim 1, wherein the core turbine engine comprises an output shaft, and wherein the electric generator is operatively coupled to the output shaft of the core turbine engine.

8. The power generation system of claim 7, wherein the core turbine engine is configured as part of a gas turbine engine, and wherein the gas turbine engine defines a bypass path bypassing the auxiliary compressor.

9. The power generation system of claim 7, wherein the turbine of the core turbine engine is a high pressure turbine, wherein the core turbine engine further comprises a low pressure turbine positioned downstream from the high pressure turbine, and wherein the low pressure turbine is coupled to the output shaft.

10. The power generation system of claim 1, wherein the core turbine engine comprises a shaft coupling the turbine to the compressor, wherein the auxiliary compressor rotates coaxially with the shaft of the core turbine engine about the axial direction.

11. The power generation system of claim 1, wherein the core turbine engine comprises a shaft coupling the turbine to the compressor, and wherein the auxiliary compressor is misaligned with the shaft of the core turbine engine.

12. A method of operating a power generation system comprising a core turbine engine, an electric generator, an electric motor, and an auxiliary compressor, the method comprising:
rotating the electric generator with the core turbine engine to generate electrical power with the electric generator;
powering the electric motor with a portion of the electric power generated by the electric generator; and
driving the auxiliary compressor with the electric motor to compress an airflow provided to a compressor of the core turbine engine.

13. The method of claim 12, wherein driving the auxiliary compressor further comprises controlling an operation of the auxiliary compressor with a controller that is communicatively coupled to the electric motor.

14. The method of claim 13, wherein controlling the operation of the auxiliary compressor includes controlling the operation of the electric motor.

15. The method of claim 12, wherein the auxiliary compressor comprises an array of airfoils rotatable by the electric motor.

16. The method of claim 12, wherein the core turbine engine comprises an output shaft, and wherein the electric generator is operatively coupled to the output shaft of the core turbine engine.

17. The method of claim 16, wherein the core turbine engine is configured as part of a gas turbine engine, and wherein the gas turbine engine defines a bypass path bypassing the auxiliary compressor.

18. The method of claim 17, wherein the turbine of the core turbine engine is a high pressure turbine, wherein the core turbine engine further comprises a low pressure turbine positioned downstream from the high pressure, and wherein the low pressure turbine is coupled to the output shaft.

19. The method of claim 12, wherein the core turbine engine comprises a shaft coupling the turbine to the compressor, and wherein the auxiliary compressor rotates coaxially with the shaft of the core turbine engine about the axial direction.

20. The method of claim 12, wherein the core turbine engine comprises a shaft coupling the turbine to the compressor, and wherein the auxiliary compressor is misaligned with the shaft of the core turbine engine.
